(19) United States
(12) Patent Application Publication
(10) Pub. No.: US 2022/0169089 A1
(43) Pub. Date: Jun. 2, 2022

(54) POWER CIRCUIT FOR A RECREATIONAL VEHICLE

(71) Applicant: Haier US Appliance Solutions, Inc., Wilmington, DE (US)

(72) Inventor: Richard Dustin Henderson, La Grange, KY (US)

(21) Appl. No.: 17/106,467

(22) Filed: Nov. 30, 2020

(51) Int. Cl. B60H 1/00; B60L 1/00

(52) U.S. Cl. CPC B60H 1/00364; B60H 1/00528; B60L 1/00

(57) ABSTRACT

A power circuit for a recreational vehicle includes a plurality of electronic devices of the recreational vehicle that require direct current (DC) power for operation. Each of the plurality of electronic devices includes a circuit board. The power circuit for a recreational vehicle also includes a single DC power supply electrically coupled directly to a first circuit board of a first electronic device of the plurality of electronic devices via a first wired connection. Thus, the DC power is supplied to the first electronic device. Further, the power circuit also includes electrically coupling the remaining circuit boards of the plurality of electronic devices to the first circuit board via a daisy chain sequence separate from the first wired connection. Accordingly, the remaining circuit boards of the plurality of electronic devices receive the DC power from the single DC power supply via the daisy chain sequence.

### FIELD OF THE INVENTION

The present subject matter relates generally to power circuits, and more particularly, to power circuits for providing power to multiple electronic devices, such as air conditioning units, in a recreational vehicle.

### BACKGROUND OF THE INVENTION

Generally, recreational vehicles include various electronic devices, such as a recreational vehicle air conditioner (RVAC), that require direct current (DC) power for operation. As such, the RVAC is configured to maintain a comfortable temperature within the passenger compartment of the recreational vehicle. Typically, the air conditioning unit is mounted on the roof or another exterior location of the recreational vehicle and utilizes a sealed system for circulation refrigerant between an indoor and outdoor heat exchanger to facilitate heat transfer. For example, the indoor heat exchanger may be positioned within an indoor portion of the RVAC and may be in fluid communication with the passenger compartment through an opening in the roof. The outdoor heat exchanger may be positioned within the outdoor portion and separated from the indoor heat exchanger by a partition or divider.

Conventional recreational vehicles typically include multiple AC units and their controls. As such, the power is commonly provided to the AC units and their controls through multiple, separate electrical connections. However, this type of circuit necessitates multiple power sources so that there can be a power source for each electrical connection and therefore a power source for each AC unit and control. Thus, known RVAC systems can be cumbersome for the manufacturer.

Accordingly, an improved RVAC system that addresses the aforementioned issues would be welcomed in the art. Thus, the present disclosure is directed to an improved power circuit for providing power to multiple electronic units in a recreational vehicle that includes a single DC power source.

### BRIEF DESCRIPTION OF THE INVENTION

Aspects and advantages of the invention will be set forth in part in the following description, or may be apparent from the description, or may be learned through practice of the invention.

In one aspect, a power circuit for a recreational vehicle is provided. The power circuit includes a plurality of electronic devices of the recreational vehicle that require direct current (DC) power for operation. The plurality of electronic devices each include a circuit board and a single DC power supply. The power circuit includes the single DC power supply electrically coupled directly to a first circuit board of a first electronic device of the plurality of electronic devices. The power circuit includes the single DC power supply electrically coupled to the first circuit board via a first wired connection so as to supply the DC power to the first electronic device. The power circuit also includes electrically coupling the remaining circuit board of the plurality of electronic devices. Further, the power circuit includes electrically coupling the remaining circuit boards to the first circuit board via a daisy chain sequence. The daisy chain sequence is separate from the first wired connection. Moreover, remaining circuit boards of the plurality of the electronic devices receive the DC power from the single DC power supply via the daisy chain sequence.

In another aspect, a method for supplying power to a plurality of electronic devices in a recreational vehicle is provided. The method includes electrically coupling a single DC power supply directly to a first circuit board of a first electronic device of a plurality of electronic devices. Further, the method includes coupling the single DC power supply directly to a first circuit board via a first wired connection so as to supply DC power to the first electronic device. Moreover, the method includes electrically coupling remaining circuit boards of the plurality of electronic devices to the first circuit board. In addition, the method includes electrically coupling the remaining circuit boards to the first circuit board via a daisy chain sequence. The daisy chain sequence is separate from the first wired connection. As such, the method includes providing the DC power to the remaining circuit boards of the plurality of electronic devices from the single DC power supply. In addition, the method includes providing the DC power to the remaining circuit boards via the daisy chain sequence.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a recreational vehicle according to an exemplary embodiment of the present disclosure.

FIG. 2 provides a perspective view of a recreational vehicle air conditioner (RVAC) that may be used with the exemplary recreational vehicle of FIG. 1, with an outdoor cover removed for clarity.

FIG. 3 provides a perspective view of the exemplary RVAC of FIG. 2 with an indoor cover removed for clarity.

FIG. 4 provides a schematic view of an air conditioning system according to an exemplary embodiment of the present disclosure.

FIG. 5 provides a schematic view of an air conditioning power circuit for a recreational vehicle according to an exemplary embodiment of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In order to aid understanding of this disclosure, several terms are defined below. The defined terms are understood to have meanings commonly recognized by persons of ordinary skill in the arts relevant to the present invention. The terms “includes” and “including” are intended to be inclusive in a manner similar to the term “comprising.” Similarly, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components. In addition, as used herein, terms of approximation, such as “approximately,” “substantially,” or “about,” refer to being within a ten percent margin of error.

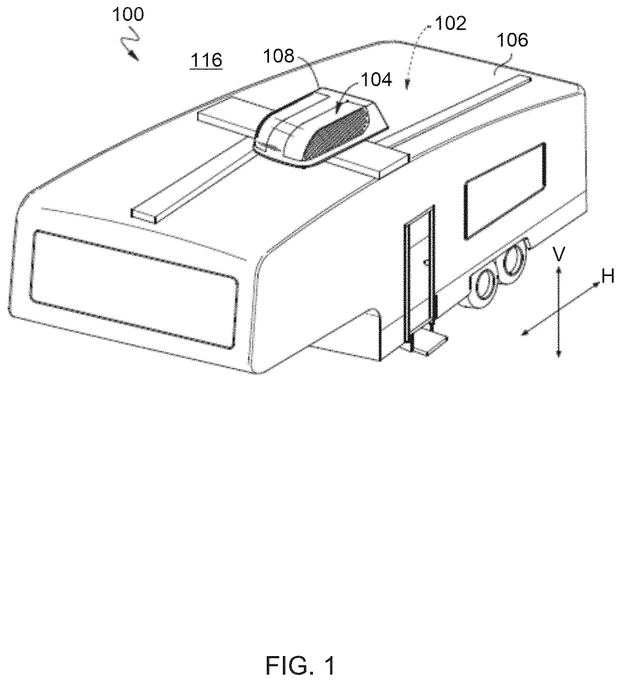

Referring now to the figures, FIG. 1 provides a perspective view of an exemplary recreational vehicle 100 in accordance with the present disclosure. Example recreational vehicles 100 may be utilized for a variety of purposes, including but not limited to transportation, cooking, eating, sleeping, entertaining, and the like. Thus, as shown, the recreational vehicle 100 generally defines a passenger compartment 102, which may further include various essentials for transformational living, such as sleeping quarters, a kitchen area, an eating area, a restroom, or similar, as well as additional compartments for storing items during travel.

In addition, the passenger compartment 102 of recreational vehicle 100 also includes climate control to maintain a comfortable temperature during use of the vehicle 100. Accordingly, as shown, the recreational vehicle 100 also includes an air conditioning unit 104 for controlling the temperature within the passenger compartment 102. In particular, as shown in the illustrated embodiment, the passenger compartment 102 may be mounted to an exterior surface 106, such as the top surface, of the recreational vehicle 100 to provide cooled air to the passenger compartment 102. It should be further understood that the air conditioning system 104 may also be mounted to any other exterior surface 106 of the recreational vehicle 100 in addition to the top surface. Accordingly, in an embodiment, this arrangement is desirable because a byproduct of operation of the air conditioning system 104 is heated air, which has been passed over a heat exchanger to remove heat from the air circulating within the passenger compartment 102. More particularly, during certain operations, this heated air may be exhausted to the ambient air.

In addition, as shown in FIG. 1, the air conditioning system 104 may also include a top cover 108 positioned over the working components of the air conditioning system 104, e.g., to protect such working components from rain, wind, debris, etc. Although an exemplary recreational vehicle 100 is illustrated, it should be appreciated that the air conditioning system 104 may be further used in or with any suitable recreational vehicle now known or later developed in the art.

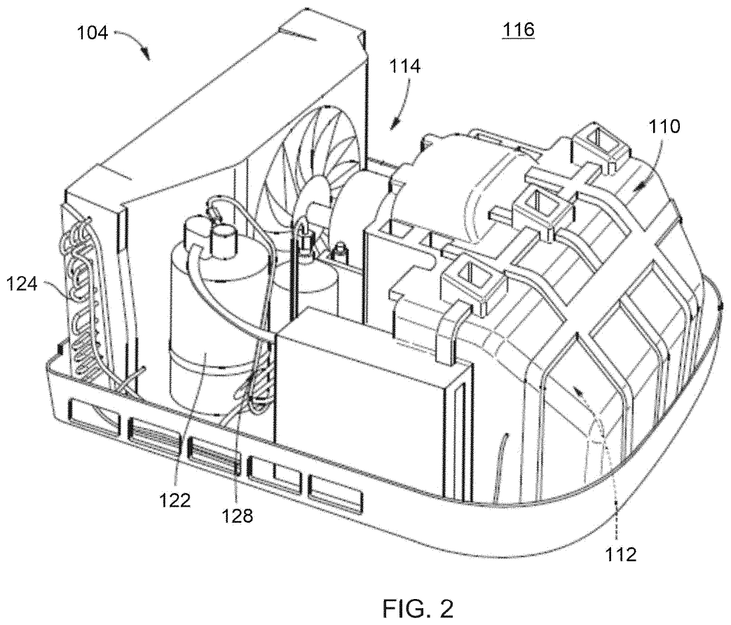

Referring now specifically to FIGS. 2 through 4, the operation of the air conditioning system 104 is described in more detail according to exemplary embodiments of the present subject matter. In this regard, FIG. 2 illustrates a top, perspective view of the air conditioning unit 104 of the recreational vehicle 100 with the cover 108 removed to reveal internal working components thereof. As illustrated, the air conditioning unit 104 generally includes an indoor bulkhead or indoor cover 110 that divides the air conditioning unit 104 between an indoor and outdoor portion, such as in a packaged terminal air conditioner unit (PTAC) or a split heat pump system. Specifically, in an embodiment, the indoor cover 110 defines and indoor air plenum 112 and an outdoor air plenum 114. In this regard, the indoor cover 110 generally shields the indoor components of the air conditioning unit 104 from the outdoor environment 116.

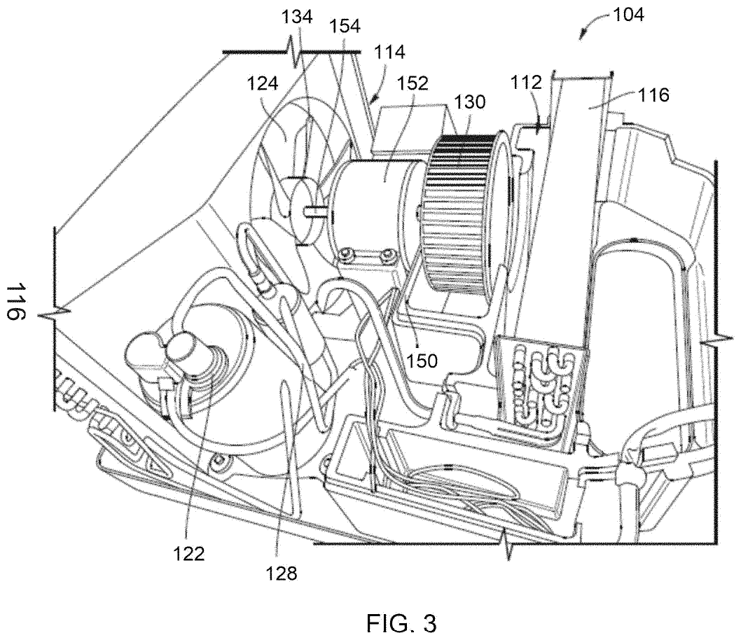

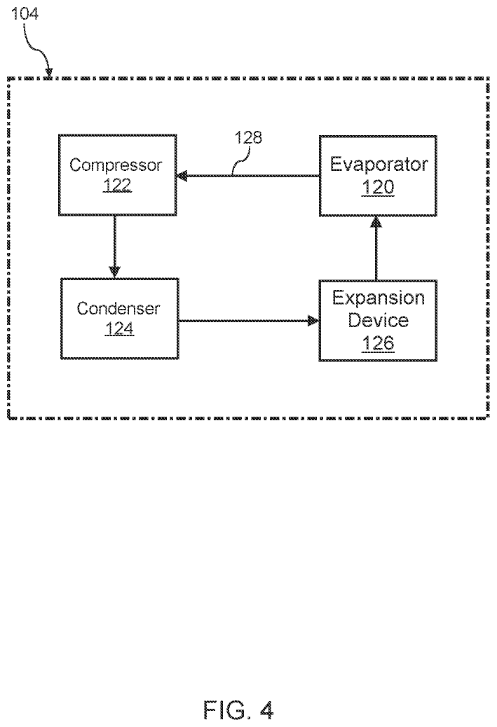

Referring particularly to FIG. 3, the indoor cover 110 is removed to reveal additional working components of the air conditioning unit 104. In addition, FIG. 4 illustrates a schematic view of the air conditioning unit 100. Relevant components of the air conditioning unit 104 are be described in more detail. In particular, it should be understood that air conditioning unit 104 includes various heat pump components, such as a sealed system, for treating air within an interior of the recreational vehicle 100. Such components are well understood by those skilled in the art.

In particular, for example, the air conditioning unit 104 includes refrigerant circulating between an evaporator 120, a compressor 122, a condenser 124, and an expansion device 126, as shown in the refrigeration loop 128 of air conditioning unit 104 in FIGS. 2 through 4. Therefore, refrigerant, also known as coolant, carries heat from the passenger compartment 102 of the recreational vehicle 100 to the outdoors 116 (e.g., ambient area surrounding the exterior surface 106 of the passenger compartment 102). In such embodiments, refrigerant can be useful because it changes states from a liquid to a vapor at convenient temperatures for a refrigeration cycle. One suitable refrigerant for use in the refrigeration loop 128 may include, for example, 1,1,1,2-Tetrafluoroethane, also known as R-134A, although it should be understood that the present disclosure is not limited to such example and that any suitable refrigerant may be utilized. For example, according to an exemplary embodiment, the refrigerant may be R-410A or any other refrigerant.

Accordingly, during operation, the refrigerant begins by passing through the evaporator 120 in liquid form. Ambient air or air from the passenger compartment 102 may pass over the evaporator 120, e.g., as motivated by an evaporator air handler. More specifically, as illustrated, the air conditioning unit system 104 may include an indoor fan 130 configured for urging a flow of indoor air. Because the liquid refrigerant is cold in this low-pressure state, it absorbs heat from the air passed over it, cooling the air for delivery to the passenger compartment 102. As the liquid refrigerant absorbs heat, the refrigerant evaporates into a vapor. Subsequently, the gaseous refrigerant is delivered to the compressor 122, which increases the pressure of the refrigerant, thus raising the temperature of the refrigerant above the ambient temperature outside of the recreational vehicle 100. From the compressor 122, the heated refrigerant is delivered to the condenser 124. Air may pass over the condenser 124, e.g., as motivated from a condenser air handler. More specifically, as illustrated, the air conditioning unit 104 may include an outdoor fan 132 configured for urging a flow of outdoor air, thereby facilitating heat transfer from the heated refrigerant to the ambient air. In releasing this heat energy, the refrigerant condenses back into liquid form. The refrigerant is then delivered to the expansion device 126, where the pressure of the refrigerant is reduced, thus decreasing its temperature. The cooled, liquid refrigerant is then delivered back to the evaporator 120 to repeat the process.

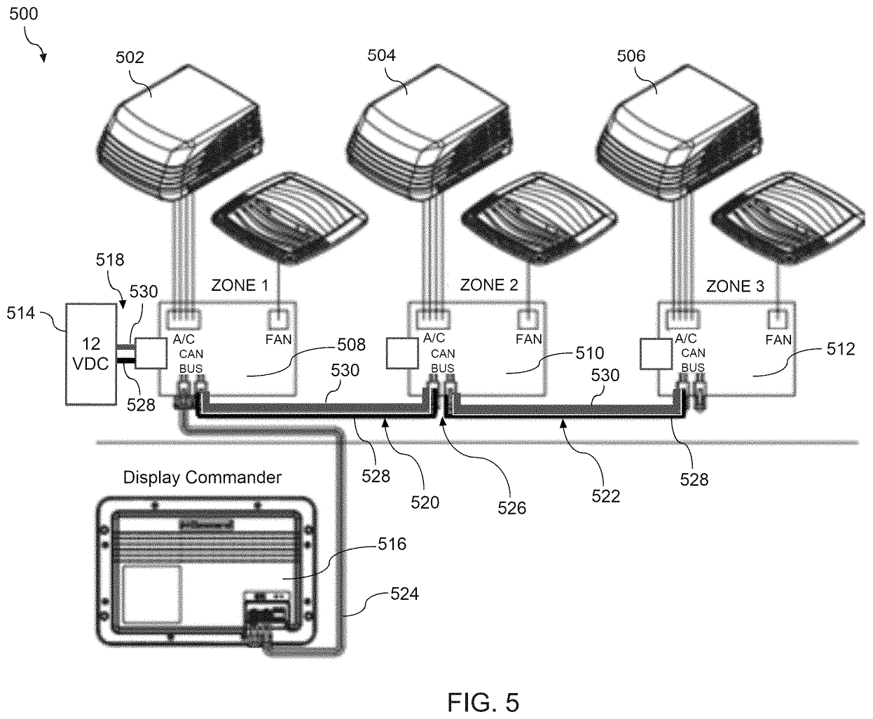

Referring now to FIG. 5, an exemplary schematic diagram of a power circuit 500 for a recreational vehicle, such as recreational vehicle 100, is provided. More specifically, as shown, the power circuit 500 includes a plurality of electronic devices (e.g., up to eight electronic devices) electrically coupled together. In particular, the power circuit 500 includes a plurality of AC units (e.g., first AC unit 502, second AC unit 504, and third AC unit 506) electrically coupled together via respective circuit boards corresponding to each AC unit (e.g., first circuit board 508, second circuit board 510, and third circuit board 512).

For example, as shown, the first circuit board 508 can be coupled to a single DC power supply 514 (e.g., a 12-volt DC power supply). More specifically, as shown, the single DC power supply 514 can be electrically coupled to the first circuit board 508 via a first wired connection 518 so as to supply the DC power to the first electronic device (e.g., the first AC unit 502). Thus, as shown, the remaining circuit boards of the power circuit 500 (e.g. circuit boards 510 and 512) may be electrically coupled to the first circuit board 508 via a daisy chain sequence 526. As used herein, a daisy chain sequence 526 generally refers to a wiring scheme in which multiple devices are wired together in a sequence, similar to a garland of daisy flowers. In particular, as shown in FIG. 5, the first circuit board 508 can be coupled to the second circuit board 510 via a second wired connection 520 and the second circuit board 510 can be coupled to the third circuit board 512 via a third wired connection 522 to form the daisy chain sequence 526 described herein. In addition, as shown, the daisy chain sequence 526 is separate from the first wired connection 518. Accordingly, the remaining circuit boards 510, 512 of the plurality of the electronic devices can receive the DC power from the single DC power supply 514 via the daisy chain sequence 526.

Referring now in particular to the wired connections 518, 520, 522 of the power circuit 500, the wired connections may include power wiring components 528 and/or communication wiring components 530. Specifically, as shown, each of the wired connections 518, 520 522 include both power 528 and communication 530 wiring components. Moreover, any of the wired connections 518, 520, and 522 can be an RV-C connection. For example, in an embodiment, the first wire connection 518 may be an RV-C connection, whereas the second wired connection 520 and third wired connection 522 may be an RV-X connection.

In some implementations, the power circuit 500 may have more than one DC power supply. For instance, more than one DC power supply may be coupled to the first circuit board 508 via a first wired connection 518 so as to supply the DC power to the first electronic device (e.g., the first AC unit 502). In some implementations, the power circuit 500 may also utilize any other suitable power supply in addition to DC power supplies.

In some implementations, the power circuit 500 may be communicatively coupled to a user interface of the recreational vehicle. For instance, the user interface may be a display commander 516 communicatively coupled via a fourth wired connection 524.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A power circuit for a recreational vehicle, comprising:
a plurality of electronic devices of the recreational vehicle that require direct current (DC) power for operation, each of the plurality of electronic devices comprising a circuit board; and
a single DC power supply electrically coupled directly to a first circuit board of a first electronic device of the plurality of electronic devices via a first wired connection so as to supply the DC power to the first electronic device,
wherein remaining circuit boards of the plurality of electronic devices are electrically coupled to the first circuit board via a daisy chain sequence separate from the first wired connection, and
wherein the remaining circuit boards of the plurality of electronic devices receive the DC power from the single DC power supply via the daisy chain sequence.

2. The power circuit of claim 1, wherein the plurality of electronic devices comprises a plurality of air conditioning units.

3. The power circuit of claim 1, wherein the first wired connection comprises power and communication wiring.

4. The power circuit of claim 3, wherein the communication wiring of the first wired connection comprises an RV-C connection.

5. The power circuit of claim 1, wherein the daisy-chain sequence comprises power and communication wiring.

6. The power circuit of claim 5, wherein the communication wiring of the daisy-chain sequence comprises an RV-C connection.

7. The power circuit of claim 1, wherein the single DC power supply comprises a 12-volt DC power supply.

8. The power circuit of claim 1, wherein the first circuit board of the power circuit is further electrically coupled to an additional power supply.

9. The power circuit of claim 1, wherein the plurality of electronic devices comprises up to a maximum of eight (8) electronic devices.

10. The power circuit of claim 1, wherein the power circuit is communicatively coupled to a user interface of the recreational vehicle.

11. A method for supplying power to a plurality of electronic devices in a recreational vehicle, the method comprising:
electrically coupling a single DC power supply directly to a first circuit board of a first electronic device of a plurality of electronic devices via a first wired connection so as to supply DC power to the first electronic device;
electrically coupling remaining circuit boards of the plurality of electronic devices to the first circuit board via a daisy chain sequence separate from the first wired connection; and
providing the DC power to the remaining circuit boards of the plurality of electronic devices from the single DC power supply via the daisy chain sequence.

12. The method of claim 11, wherein the plurality of electronic devices comprises a plurality of air conditioning units.

13. The method of claim 11, wherein the first wired connection comprises power and communication wiring.

14. The method of claim 13, wherein the communication wiring of the first wired connection comprises an RV-C connection.

15. The method of claim 11, wherein the daisy-chain sequence comprises power and communication wiring.

16. The method of claim 15, wherein the communication wiring of the daisy-chain sequence comprises an RV-C connection.

17. The method of claim 11, wherein the single DC power supply comprises a 12-volt DC power supply.

18. The method of claim 11, wherein the first circuit board of the power circuit is further electrically coupled to an additional power supply.

19. The method of claim 11, wherein the plurality of electronic devices comprises up to a maximum of eight (8) electronic devices.

20. The method of claim 11, wherein the power circuit is communicatively coupled to a user interface of the recreational vehicle.
